(19) United States
(12) Patent Application Publication
(10) Pub. No.: US 2025/0293527 A1
(43) Pub. Date: Sep. 18, 2025

(54) PROGRAMMABLE CHARGING SYSTEM FOR A PLURALITY OF RECHARGABLE BATTERIES

(71) Applicant: MICROPOWER GROUP AB, Växjö (SE)

(72) Inventor: Andreas SVENSSON, Tibro (SE)

(21) Appl. No.: 18/859,764

(22) PCT Filed: May 31, 2023
(86) PCT No.: PCT/EP2023/064568

§ 371 Date: Oct. 24, 2024

(30) Foreign Application Priority Data
Jun. 14, 2022 (SE) 2250710-7

(51) Int. Cl. H02J 7/00

(52) U.S. Cl. CPC H02J 7/0013; H02J 7/00714; H02J 7/007182; H02J 2207/20

(57) ABSTRACT

A method (300) for charging battery modules (4) using a charger system (1). The charger system (1) comprises a master DC-source (2) configured to provide a master voltage with a variable magnitude to a plurality of DC/DC-converters (3). Each DC/DC-converter in the plurality of DC/DC-converters (3) is configured to provide an output voltage and an output current to charge a respective battery module (4). The method comprises: obtaining (310) a desired charging voltage for each battery module (4) connected to a respective DC/DC-converter in the plurality of DC/DC-converters (3); obtaining (320) a possible output current for each DC/DC-converter in the plurality of DC/DC-converters (3) connected to a respective battery module (4); determining (330) a magnitude of the master voltage in dependency of an estimated power consumption of at least two DC/DC-converters in the plurality of DC/DC-converters (3) connected to a respective battery module (4) if the at least two DC/DC-converter in the plurality of DC/DC-converters (3) connected to a respective battery module (4) would charge the respective connected battery modules (4) with the respective desired charging voltages and the respective possible output currents; and charging (340) the respective battery modules (4) connected to the at least two DC/DC-converter in the plurality of DC/DC-converters (3) with the respective desired charging voltages, with the respective possible output currents, and with the master DC-source (2) providing the master voltage with the determined magnitude.

### TECHNICAL FIELD

The present disclosure relates to a method for charging battery modules using a charger system, a charger system for charging battery modules, a computer program product, and a computer program carrier.

### BACKGROUND

Rechargeable batteries are used more and more for all kinds of products. Smaller rechargeable batteries are used in wearable and portable products, such as watches, phones, cameras, flashlights etc. These batteries are mostly built into the product and cannot be changed. The rechargeable battery and the charger are thus adapted to each other with a fixed voltage.

A battery is typically in the form of a battery module, which comprises a number of individual battery cells connected in series and/or in parallel encased in a mechanical structure. The size of the battery module typically refers to the number of individual battery cells.

Somewhat larger batteries are used e.g. for power tools or bicycles. These are also normally provided with a single voltage, or in some cases with two different voltages, and are also charged with a dedicated charger adapted for the voltage of the rechargeable battery.

Very large rechargeable batteries are used in e.g. vehicles of different kinds, such as passenger cars, delivery trucks and smaller boats. These are also fixedly installed in the vehicle and have a single voltage, but may be charged with different voltages through a flexible charger that can convert the input voltage to a charging voltage for the rechargeable battery. These converters are adapted to scale down the charging voltage but not to scale the voltage to a higher voltage.

Medium rechargeable batteries may be used for smaller vehicles and machines, both for industrial use and for private use. This may include cleaning machines, forklifts, utility vehicles, industrial installations, etc. The rechargeable batteries may be fixedly installed or may be replaceable. Different machines and vehicles in an industry may require different voltages and the industry may also have different chargers with different output voltages. It is e.g. possible that forklifts from the same supplier use different rechargeable batteries depending on the size, age or version of the forklift. This complicates the maintenance of the complete system since different batteries must be stocked for replacement and several different chargers must be installed for charging. Further, different rechargeable batteries may require different charging curves, such that different rechargeable batteries provided with the same voltage still require different chargers.

Often, many rechargeable batteries must be charged at the same time. Normally, each battery type is provided with a specific AC/DC-charger that is connected to mains, and that is provided with a specific output voltage and output current. In larger installations, one large AC/DC-converter may be used, to which several dedicated DC/DC-converters are connected, where each DC/DC-converter is adapted to charge a specific battery or battery type. Such systems may be rather inflexible and may further be rather energy inefficient.

There is thus room for an improved charging system for charging a plurality of battery modules.

### SUMMARY

It is an object of the present disclosure to provide improved ways of charging a plurality of battery modules. This object is at least in part achieved by a method for charging battery modules using a charger system. The charger system comprises a master DC-source configured to provide a master voltage with a variable magnitude to a plurality of DC/DC-converters. Each DC/DC-converter in the plurality of DC/DC-converters is configured to provide an output voltage and an output current to charge a respective battery module. The method comprises obtaining a desired charging voltage for each battery module connected to a respective DC/DC-converter in the plurality of DC/DC-converters. The method further comprises obtaining a possible output current for each DC/DC-converter in the plurality of DC/DC-converters connected to a respective battery module. The method also comprises determining a magnitude of the master voltage in dependency of an estimated power consumption of at least two DC/DC-converters in the plurality of DC/DC-converters connected to a respective battery module if the at least two DC/DC-converter in the plurality of DC/DC-converters connected to a respective battery module would charge the respective connected battery modules with the respective desired charging voltages and the respective possible output currents. The method further comprises charging the respective battery modules connected to the at least two DC/DC-converter in the plurality of DC/DC-converters with the respective desired charging voltages, with the respective possible output currents, and with the master DC-source providing the master voltage with the determined magnitude.

The charger system is adapted to charge different battery modules having different voltages and different charging current requirements.

Setting the magnitude of the master voltage in dependency of the estimated power enables a reduction of the power consumption of the least two DC/DC-converters in the plurality of DC/DC-converters during charging.

Preferably, the method comprises determining the magnitude of the master voltage in dependency of an estimated power consumption of all DC/DC-converters in the plurality of DC/DC-converters connected to a respective battery module. In this way, the power consumption of the charger system may be reduced during charging. Similarly, the charging preferably comprises charging the respective battery modules connected to all DC/DC-converter in the plurality of DC/DC-converters with the respective desired charging voltages, with the respective possible output currents, and with the master DC-source providing the master voltage with the determined magnitude.

According to some aspects, the magnitude of the master voltage is determined such that the estimated power consumption is equal to or reduced relative to if the master DC-source would provide the master voltage with a nominal magnitude. In this way, the power consumption during charging of the least two DC/DC-converters in the plurality of DC/DC-converters is reduced or equal to relative to a power consumption the charger system would have had if the master DC-source would have provided the master voltage with the nominal magnitude during charging.

According to some aspects, the magnitude of the master voltage is determined such that the estimated power consumption is minimized. In other words, the magnitude of the master voltage is selected among all possible magnitudes the master DC-source is capable of providing that yields the lowest estimated power consumption.

According to some aspects, the obtaining of a possible output current for each DC/DC-converter in the plurality of DC/DC-converters connected to a respective battery module comprises: obtaining a desired charging current for each battery module connected to a respective DC/DC-converter in the plurality of DC/DC-converters; obtaining a total available current from the master DC-source; and determining the possible output current for each DC/DC-converter in the plurality of DC/DC-converters connected to a respective battery module in dependency of the total available current from the master DC-source and of the desired charging currents. This ensures that the current output of the master DC-source is not overloaded. If the total available current from the master DC-source is larger than the sum of all desired charging currents, the respective possible output currents may be selected as the respective desired currents. If, on the other hand, the total available current from the master DC-source is lower than the sum of all desired charging currents, the respective possible output currents may be selected as respective fractions the respective desired currents.

According to some aspects, the possible output currents are determined based on one or more prioritized battery modules among the connected battery modules. This enables the one or more prioritized battery modules to be charged at desired rates. If, for example, the total available current from the master DC-source is lower than the sum of all desired charging currents, the respective possible output currents may be selected as respective fractions the respective desired currents, except for the prioritized battery modules, where the corresponding possible output currents are selected as the associated desired currents.

According to some aspects, the possible charging currents are determined based on a respective state-of-charge (SOC) of one or more of the connected battery modules. This enables, e.g., battery modules with the lowest SOC to be charged at desired rates. If, for example, the total available current from the master DC-source is lower than the sum of all desired charging currents, the respective possible output currents may be selected as respective fractions the respective desired currents, except for the battery module with the lowest SOC, for which the corresponding possible output current is selected as the associated desired current.

According to some aspects, the desired charging currents are obtained from a respective battery management system (BMS) comprised in each connected battery module. Additionally, or alternatively, the desired charging voltages may be obtained from a respective BMS comprised in each connected battery module. This provides a fast way of obtaining the desired charging currents and/or desired charging voltages. In alternative embodiments, the desired charging currents and/or desired charging voltages are obtained from measurements of the connected battery modules by the respective DC/DC-converters.

The estimated power consumption for one DC/DC converter may be based on the voltage conversion ratio of that DC/DC converter (i.e. the voltage drop ratio or voltage increase ratio from the master voltage to the output of that DC/DC converter) and on the possible current flowing through that DC/DC converter during charging. Preferably, the estimated power consumption of the at least two DC/DC-converters is estimated in such way for an accurate estimation of the power consumption.

However, the estimated power consumption of the at least two DC/DC-converters may be estimated from voltage conversation ratios alone or from possible charging currents. In some cases, this may provide sufficient accuracy of the estimation. In summary, the estimated power consumption may be based on respective voltage conversation ratios of the at least two DC/DC-converters in the plurality of DC/DC-converters. Furthermore, the estimated power consumption may be based on the respective possible charging currents of the at least two DC/DC-converters in the plurality of DC/DC-converters.

According to some aspects, the desired charging voltage is a voltage over a time period and the possible charging current is a current over a time period. Similarly, the desired charging current may be current over a time period.

According to some aspects, the master DC-source is an AC/DC-converter arranged to convert an AC voltage to the master voltage. The AC voltage may, e.g., be mains voltage. The master DC-source may alternatively be a DC/DC-converter that converts a DC voltage to another DC voltage (i.e., the master voltage), e.g. from a battery or another fixed DC-source.

There is also disclosed herein a charger system for charging battery modules. The charger system is associated with the above-discussed advantages. The charger system comprises a master DC-source and a plurality of the DC/DC-converters. The master DC-source is configured to provide a master voltage with a variable magnitude to the plurality of DC/DC-converters. Each DC/DC-converter in the plurality of DC/DC-converters is configured to provide an output voltage and an output current to charge a respective battery module. The charger system comprises a processing circuitry and a memory. The processing circuitry is configured to obtain a desired charging voltage for each battery module connected to a respective DC/DC-converter in the plurality of DC/DC-converters. The processing circuitry is further configured to obtain a possible output current for each DC/DC-converter in the plurality of DC/DC-converters connected to a respective battery module. The processing circuitry is also configured to determine a magnitude of the master voltage in dependency of an estimated power consumption of at least two DC/DC-converters in the plurality of DC/DC-converters connected to a respective battery module if the at least two DC/DC-converter in the plurality of DC/DC-converters connected to a respective battery module would charge the respective connected battery modules with the respective desired charging voltages and the respective possible output currents. The processing circuitry is further configured to charge the respective battery modules connected to the at least two DC/DC-converter in the plurality of DC/DC-converters with the respective desired charging voltages, with the respective possible output currents, and with the master DC-source providing the master voltage with the determined magnitude.

There is also disclosed herein a computer program product comprising instructions which, when executed on at least one processing circuitry, cause the at least one processing circuitry to carry out the method according to the discussion above. The computer program is associated with the above-discussed advantages.

There is also disclosed herein a computer program carrier carrying a computer program product according to the discussion above, wherein the computer program carrier is one of an electronic signal, optical signal, radio signal, or computer-readable storage medium. The computer program carrier is associated with the above-discussed advantages.

### BRIEF DESCRIPTION OF THE DRAWINGS

With reference to the appended drawings, below follows a more detailed description of embodiments of the present disclosure cited as examples. In the drawings:

FIG. 1 shows a schematic view of a charger system;

FIG. 2 is a flow chart illustrating a method; and

FIG. 3 is a flow chart illustrating a method.

### DETAILED DESCRIPTION

The present disclosure is described more fully below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

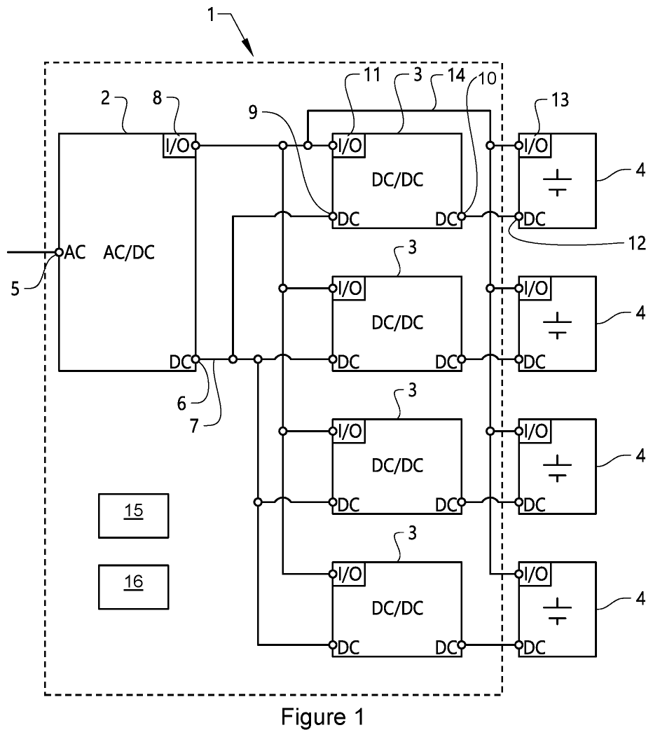

FIG. 1 shows a schematic example of a charger system 1 for charging battery modules 4. The charger system 1 comprises a master DC-source 2 and a plurality of DC/DC-converters 3. The master DC-source 2 is configured to provide a master voltage with a variable magnitude to the plurality of DC/DC-converters 3. The master voltage is a DC voltage and the master DC-source 2 is configured to set a magnitude of that DC voltage, normally from a span of different DC voltages the master DC-source 2 is capable of providing (e.g., 1-100 V). Each DC/DC-converter in the plurality of DC/DC-converters 3 is configured to provide an output voltage and an output current to charge a respective battery module 4. Each output voltage is a DC voltage and each DC/DC-converters 3 is configured to convert the master voltage to a desired output voltage. The output voltage by each DC/DC converter is set to a desired charging voltage by the connected battery module, which may correspond to the particular configuration of the cells of that battery module.

In the example in FIG. 1, the charger system 1 comprises four DC/DC-converters 3 connected to respective battery modules 4, but the charger system 1 may comprise any number of DC/DC-converters 3. Each DC/DC-converter 3 is assigned to one battery module 4, i.e. each DC/DC-converter 3 will only charge a single battery module 4.

The master DC-source 2 may be an AC/DC-converter arranged to convert an AC voltage to the master voltage. For example, the master DC-source 2 may be an AC/DC-converter that converts an AC voltage from the mains to the master voltage. The master DC-source 2 may alternatively be a DC/DC-converter that converts a first DC voltage (e.g., from a battery or another fixed DC-source) to a second DC voltage (i.e. the master voltage). In the example of FIG. 1, an AC/DC-converter is used as an example of the master DC-source 2.

The charger system 1 is adapted to charge a number of similar or different battery modules 4, where it pays off to minimize the power loss of the charger system 1. The power loss of the charger system 1 may also be called power consumption of the charger system. The power loss of the charger system 1 may also be expressed in terms of the energy efficiency of the charger system 1.

Furthermore, the charger system 1 is adapted to charge different battery modules 4 having different voltages and charge current requirements, and that may also have different charge current profiles. As an example, battery modules of 24-96 V may be charged. Alternatively, or in combination of, the battery modules may have different chemistry that requires different charge curves. In addition, the battery modules that are to be charged may have different state of charge (SOC) such that they require different charging currents.

In the example of FIG. 1, the master DC-source 2 (i.e., the AC/DC-converter) is connected to the mains through an AC input 5. The master DC-source 2 converts the AC voltage of the mains to the master voltage (which is a DC voltage) that is fed to the DC bus 7 of the charger system 1 through a DC output 6. Each DC/DC-converter 3 is connected to the DC bus 7 through a DC input 9. Each DC/DC-converter 3 is provided with a DC output 10 that is connected to a DC input 12 of a battery module 4 that is to be charged. As mentioned, each DC/DC-converter 3 is adapted to charge a single rechargeable battery module 4. Each DC/DC-converter 3 will convert the voltage of the DC bus 7 (i.e., the master voltage) to a voltage adapted to the connected battery module 4. Depending on the voltage on the DC bus 7, a DC/DC-converter 3 may comprise a buck converter adapted to convert a high voltage to a lower voltage, a boost converter adapted to convert a low voltage to a higher voltage, or a buck-boost converter adapted to convert the DC bus voltage to either a higher voltage or a lower voltage.

As mentioned, the master DC-source 2 is configured to provide a master voltage with a variable magnitude to the plurality of DC/DC-converters 3. In other words, the voltage DC bus 7 from the master DC-source 2 may be varied depending on requirements. The master DC-source 2 may adopt its output voltage (i.e. the master voltage) to the requirements of the connected battery modules 4, e.g., such that a voltage drop over the DC/DC-converters 3 may be minimized, which increases the efficiency of the charger system.

In the example of FIG. 1, each DC/DC-converter 3 comprises a control unit 11. The control unit 11 of each DC/DC-converter 3 is connected to the control units 11 of the other DC/DC-converters 3 through an interface bus 14. Through the interface bus, the control units 11 of the DC/DC-converters 3 may exchange information with each other, e.g. regarding the charge status of each DC/DC-converter (e.g. the SOC of the battery modules 4). The master DC-source 2 also comprises a control unit 8, which is also connected to the control units 11 of the DC/DC-converters 3 through the interface bus 14.

By adapting the output voltage (i.e. the master voltage) of the master DC-source 2 to the need of the connected battery modules 4, the voltage drop over the DC/DC-converters 3 may be minimized (for example on average), which may minimize the power loss and increases the efficiency of the charger system.

As an example, the four battery modules in FIG. 1 comprise two 12-V battery modules and two 24-V battery modules. In that case, it is desired to charge the 12-V battery modules with 12 V from the respective DC/DC-converters 3 they are connected to, and to charge the 24-V battery modules with 24 V from the respective DC/DC-converters 3 they are connected to. In this case, it may be desired to set the master voltage to 18 V, which is the midpoint between 12 V and 24 V, and which minimizes the maximum voltage drop/increase across all four DC/DC-converters. By using an average voltage value, the efficiency of the charger system 1 may be increased.

In the example of the previous paragraph, the power loss of the charger system 1 is minimized if the output current from each DC/DC-source 3 is equal. However, the connected battery modules may have different current needs, i.e., a desired current which may be dependent on, e.g., size, SOC, and battery chemistry. Thus, to minimize the power loss of the charger system 1, the master voltage should be selected in dependency of both the voltage drop/increase of each DC/DC-converter 3 and the output current of each DC/DC-converter 3. In other words, the master voltage may be set in dependency of an average power need of the connected battery modules. The master voltage may be selected such that the voltage drop or increase over the DC/DC-converters 3 that must handle the highest power may be minimized, which may reduce the power loss of the complete charger system.

In another example, the master voltage of the master DC-source 2 is set to conform to the desired charging voltage of the battery module having the highest current need, i.e. the highest current of all desired charging current of the connected battery modules 4. By setting the master voltage of the master DC-source 2 to correspond to the desired charging voltage battery module 4 requiring the highest charging current, the power loss of that particular DC/DC-converter is minimized. The other DC/DC-converters 3 may in this example convert the master voltage to the voltage of the connected battery module such that the DC/DC-converters 3 have to increase or decrease the master voltage to suit the connected battery modules. The DC/DC-converters 3 are in this example buck-boost converters that can convert the master voltage to a lower voltage or a higher voltage. In this way, the total energy loss of the charger system may be reduced or minimized. As mentioned, however, the master voltage should preferably be selected in dependency of both the voltage drop/increase of each DC/DC-converter 3 and the output current of each DC/DC-converter 3.

The master DC-source 2 may e.g. provide information of its total available output current, i.e., the total amount of current the master DC-source can provide to the DC bus 7. In an example, the master DC-source 2 outputs the whole amount of its total available output current to the DC/DC-converters 3. In that case, the DC/DC-converters 3 may, e.g., divide the total available current between them such that each DC/DC-converter uses the same amount of charge current to charge the connected battery modules 4.

In one example, each battery module 4 comprises a battery management system (BMS) 13. In that case, each BMS is connected to the interface bus 14 and thus to the control unit of all DC/DC-converters 3. In this case, the BMS of a battery module 4 may transmit the desired charging voltage and desired charging current to the control unit 11 of the DC/DC-converter arranged to charge that battery module 4. The BMS may further transmit information regarding the type of battery (e.g. chemistry), preferred charge profile, actual temperature etc. This allows each DC/DC-converter 3 to adapt its output current to its connected battery in dependence of the total available output current from the master DC-source 2 and of the information received from the BMS.

The control units 11 of the DC/DC-converters 3 may e.g. asses the charge status of each battery, and may select the battery that is most depleted, or the batteries that are most depleted, and decide to charge those batteries first (i.e. prioritize those batteries), depending on the available current. The other batteries are not charged at all, or are only charged with a small charge current until the first batteries are fully charged or at least partly charged. In one example, one or a few batteries may be prioritized. This information is transmitted to the control units 11 of the DC/DC-converters 3, which will charge these batteries first.

The charger system 1 may comprise a processing circuitry 15 and a memory 16. It should be noted that some or all of the functionality described in the embodiments above as being performed by the charger system 2 and/or the control units 8, 11 may be provided by the processing circuitry 15 executing instructions stored on a computer-readable medium, such as, e.g. the memory 16 shown in FIGS. 1.

To summarize, charger system 1, the processing circuitry 15, or the control units 11 of each DC/DC-converter 3 with a connected battery module 4 is configured to obtain a desired charging voltage for each battery module 4 connected to a respective DC/DC-converter in the plurality of DC/DC-converters 3. The desired charging voltage may also be called a required voltage. The desired charging voltage normally corresponds to the battery type and the particular configuration of the cells of the connected battery module. The desired charging voltages may, e.g., be obtained from a respective battery management system (BMS) comprised in each connected battery module 4. Alternatively, or in combination of, the desired charging voltage of a battery module 4 may be obtained from measurements performed by the DC/DC-converter 3 connected to that battery module.

The charger system 1, the processing circuitry 15, or the control units 11 of each DC/DC-converter 3 with a connected battery module 4 is configured to obtain a possible output current for each DC/DC-converter in the plurality of DC/DC-converters 3 connected to a respective battery module 4.

In some embodiments, the possible output current is based on a desired charging current from each connected battery module 4 and a total available current from the master DC-source 2. In that case, the charger system 1, the processing circuitry 15, or the control units 11 of each DC/DC-converter 3 with a connected battery module 4 is configured to: obtain desired charging current for each battery module 4 connected to a respective DC/DC-converter in the plurality of DC/DC-converters 3; obtain a total available current from the master DC-source 2; and determine the possible output current for each DC/DC-converter in the plurality of DC/DC-converters 3 connected to a respective battery module 4 in dependency of the total available current from the master DC-source 2 and of the desired charging currents.

In other embodiments, the possible output currents are always selected as selected as the desired charging currents. In this case, it is assumed that the master DC-source is over-dimensioned. In other words, the total available current from the master DC-source is always larger than the sum of all desired charging currents.

The desired charging voltage may be a voltage over a time period. Similarly, the desired charging current and the possible charging current may be respective currents over a time period. The desired charging current and/or the desired charging current of a battery module may be called a desired charging curve of that battery module. Each DC/DC converter 3 may be configured to charge a connected battery module with charging curve comprising the desired charging voltage over time and the possible charging current over time.

The desired charging current may also be called a required current. The desired charging current may be dependent on parameters like battery capacity, or dynamic parameters like SOC. The desired charging currents may, e.g., be obtained from a respective battery management system (BMS) comprised in each connected battery module 4. Alternatively, or in combination of, the desired charging current of a battery module 4 may be obtained from measurements performed by the DC/DC-converter 3 connected to that battery module.

The possible output currents may be determined based on one or more prioritized battery modules 4 among the connected battery modules 4. For example, if the total available current from the master DC-source 2 is 10 A, and a single prioritized battery module has a desired charging current of 9 A, the possible output currents may be determined such that the possible output current is 9 A for the prioritized battery module and the possible output currents for the remainder of battery modules is an equal fraction of 1 A.

As an example, a battery module 4 may become prioritized by a user manually pushing a button on the charger system. In another example, the charger system 2 is configured such that battery modules with a certain parameter (such as chemistry, voltage, size etc.) always is prioritized. Such parameters may be obtained from respective BMS of the battery modules.

The possible charging currents may be determined based on a respective SOC of one or more of the connected battery modules 4. The charger system 2 may, e.g., be configured such that battery modules with the lowest SOC are assigned the largest portion of the total available current from the master DC-source 2. As an example, a first battery module of four battery modules have SOC 0%, where the remaining battery modules have SOC 80%. Furthermore, all battery modules have a desired charging current of 2 A, but the total available current from the master DC-source is only 5 A. In that case, the possible charging for the first battery module may be selected as 2 A, whereas the possible charging current is selected as 1 A for each of the remaining battery modules.

The charger system 1, the processing circuitry 15, or the control unit 8 is configured to determine a magnitude of the master voltage in dependency of an estimated power consumption of at least two DC/DC-converters in the plurality of DC/DC-converters 3 connected to a respective battery module 4 if the at least two DC/DC-converter in the plurality of DC/DC-converters 3 connected to a respective battery module 4 would charge the respective connected battery modules 4 with the respective desired charging voltages and the respective possible output currents.

Setting the magnitude of the master voltage in dependency of the estimated power enables a reduction of the power consumption of the least two DC/DC-converters in the plurality of DC/DC-converters during charging.

Preferably, the method comprises determining the magnitude of the master voltage in dependency of an estimated power consumption of all DC/DC-converters in the plurality of DC/DC-converters connected to a respective battery module. In this way, the power consumption of the charger system may be reduced during charging.

In some embodiments, the magnitude of the master voltage is determined such that the estimated power consumption is minimized.

In some embodiments, the magnitude of the master voltage is determined such that the estimated power consumption is equal to or reduced relative to if the master DC-source 2 would provide the master voltage with a nominal magnitude. In this way, the power consumption during charging of the least two DC/DC-converters in the plurality of DC/DC-converters is reduced or equal to relative to a power consumption the charger system would have had if the master DC-source would have provided the master voltage with the nominal magnitude during charging.

The estimated power consumption for one DC/DC converter may be based on the voltage conversion ratio of that DC/DC converter (i.e. the voltage drop ratio or voltage increase ratio from the master voltage to the output of that DC/DC converter) and on the possible current flowing through that DC/DC converter during charging. Preferably, the estimated power consumption of the at least two DC/DC-converters is estimated in such way for an accurate estimation of the power consumption.

However, the estimated power consumption of the at least two DC/DC-converters may be estimated from voltage conversation ratios alone or from possible charging currents alone. In some cases, this may provide sufficient accuracy of the estimation. In summary, the estimated power consumption may be based on respective voltage conversation ratios of the at least two DC/DC-converters in the plurality of DC/DC-converters 3. Furthermore, the estimated power consumption may be based on the respective possible charging currents of the at least two DC/DC-converters in the plurality of DC/DC-converters 3.

The charger system 1 or the processing circuitry 15 is configured to charge the respective battery modules 4 connected to the at least two DC/DC-converter in the plurality of DC/DC-converters 3 with the respective desired charging voltages, with the respective possible output currents, and with the master DC-source 2 providing the master voltage with the determined magnitude. In other words, each of the at least two DC/DC-converter provides a respective output voltage corresponding to the desired charging voltage of the respective connected battery modules. Similarly, each of the at least two DC/DC-converter provides a respective output current corresponding to the respective possible output currents. Preferably, the charger system 1 or the processing circuitry 15 is configured to charge all respective battery modules 4 connected to the plurality of DC/DC-converters 3 with the respective desired charging voltages, with the respective possible output currents, and with the master DC-source 2 providing the master voltage with the determined magnitude.

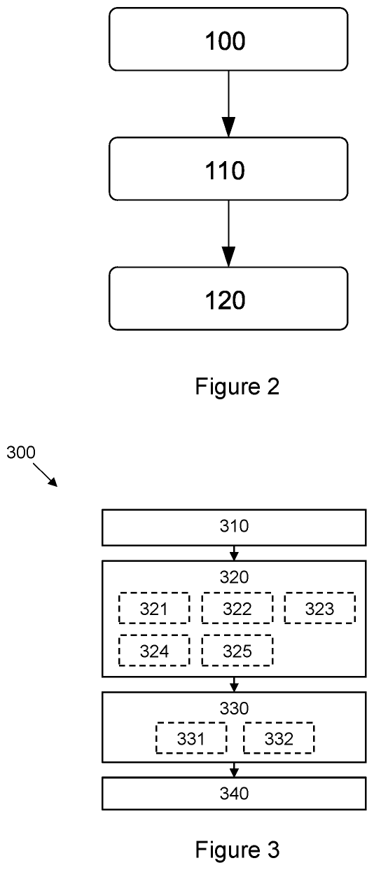

FIG. 2 shows a schematic flow chart of a method for charging a plurality of battery modules 4 using a plurality of DC/DC-converters 3, where each DC/DC-converter comprises a control unit 11 connected to the control units 11 of the other DC/DC-converters 3, and where all DC/DC-converters 3 are powered from the master DC-source 2.

In step 100, a desired charging curve for each battery module 4 is obtained and/or determined by the control units 11 of the DC/DC-converters 3. In particular, each control unit 11 obtains or determines a desired charging curve for the battery module 4 connected to that DC/DC-converter 3. A desired charging curve comprise a desired charging voltage and/or a desired charging current over time. The desired charging curve may also be called a required charging curve. The desired charging curve is in one example obtained by communication with a BMS integrated in the battery module 4. In another example, the control unit 11 measures parameters of the battery module to obtain the desired charging curve. The control unit 11 may, e.g., measure the voltage of the battery module 4, the resistance of the battery module 4, the temperature of the battery module 4, etc. These measurements allows the control unit 11 to estimate the desired charging curve. The control unit 11 may also, or alternatively, detect a serial number or a type number of the battery module 4 corresponding to the type of battery and may determine the desired charging curve, e.g. from a database.

In step 110, a possible charging curve for each battery is determined in dependency of the desired charging curve and the total available power from the master DC-source 2. The possible charging curve may also be called a unique charging curve. The battery modules 4 may have different charge status and charging needs, which means that the possible charging curve of each DC/DC-converter should be set in dependency of the possible charging curves of the other DC/DC-converters 3 and of the total available power from the master DC-source 2.

In step 120, each battery module 4 is charged with a DC/DC-converter 3 that outputs the possible charging curve for that battery module 4.

With the method shown in FIG. 2, a desired and possible charging curve may be set for each battery, where the possible charging curve may be set in dependency of the changing needs of the battery modules and the available power from the master DC-source 2. The possible charging curve for a battery module 4 may thus be set e.g. with respect to a prioritized battery, where that battery module receives its desired power and the other battery modules are either not charged at all or may share the remaining power from the master DC-source 2. It is also possible to let all batteries modules share the available power from the master DC-source 2. In one example, the output voltage of the master DC-source 2 is set in dependency of a prioritized battery module.

FIG. 3 illustrates a method 300 for charging battery modules 4 using a charger system 1, where the charger system 1 comprises a master DC-source 2 configured to provide a master voltage with a variable magnitude to a plurality of DC/DC-converters 3, where each DC/DC-converter in the plurality of DC/DC-converters 3 is configured to provide an output voltage and an output current to charge a respective battery module 4.

The method comprises: obtaining 310 a desired charging voltage for each battery module 4 connected to a respective DC/DC-converter in the plurality of DC/DC-converters 3; obtaining 320 a possible output current for each DC/DC-converter in the plurality of DC/DC-converters 3 connected to a respective battery module 4; determining 330 a magnitude of the master voltage in dependency of an estimated power consumption of at least two DC/DC-converters in the plurality of DC/DC-converters 3 connected to a respective battery module 4 if the at least two DC/DC-converter in the plurality of DC/DC-converters 3 connected to a respective battery module 4 would charge the respective connected battery modules 4 with the respective desired charging voltages and the respective possible output currents; and charging 340 the respective battery modules 4 connected to the at least two DC/DC-converter in the plurality of DC/DC-converters 3 with the respective desired charging voltages, with the respective possible output currents, and with the master DC-source 2 providing the master voltage with the determined magnitude.

The magnitude of the master voltage may be determined 331 such that the estimated power consumption is equal to or reduced relative to if the master DC-source 2 would provide the master voltage with a nominal magnitude.

The magnitude of the master voltage may be determined 332 such that the estimated power consumption is minimized.

The obtaining 320 of a possible output current for each DC/DC-converter in the plurality of DC/DC-converters 3 connected to a respective battery module 4 may comprise: obtaining 321 a desired charging current for each battery module 4 connected to a respective DC/DC-converter in the plurality of DC/DC-converters 3; obtaining 322 a total available current from the master DC-source 2; and determining 323 the possible output current for each DC/DC-converter in the plurality of DC/DC-converters 3 connected to a respective battery module 4 in dependency of the total available current from the master DC-source 2 and of the desired charging currents.

The possible output currents may be determined 324 based on one or more prioritized battery modules 4 among the connected battery modules 4.

The possible charging currents may be determined 325 based on a respective state-of-charge (SOC) of one or more of the connected battery modules 4.

The desired charging currents may be obtained from a respective battery management system (BMS) comprised in each connected battery module 4.

The desired charging voltages may be obtained from a respective battery management system (BMS) comprised in each connected battery module 4.

The estimated power consumption may be based on respective voltage conversation ratios of the at least two DC/DC-converters in the plurality of DC/DC-converters 3.

The estimated power consumption is based on the respective possible charging currents of the at least two DC/DC-converters in the plurality of DC/DC-converters 3.

The desired charging voltage may be a voltage over a time period and the possible charging current may be a current over a time period.

The master DC-source 2 may be an AC/DC-converter arranged to convert an AC voltage to the master voltage.

The methods disclosed herein may be implemented through one or more processors, such as the processing circuitry 15 in FIG. 1, together with computer program code for performing the functions and actions of the embodiments herein. The program code may also be provided as a computer program product, for instance in the form of a data carrier carrying computer program code or code means for performing the embodiments herein when being loaded into the processing circuitry 15. The computer program code may e.g. be provided as pure program code in the charger system 1 or on a server and downloaded to the charger system 1. Those skilled in the art will also appreciate that the processing circuitry 15 and the memory 16 described above may refer to a combination of analog and digital circuits, and/or one or more processors configured with software and/or firmware, e.g. stored in a memory, that when executed by the one or more processors such as the processing circuitry 15 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above-described preferred embodiments. Various alternatives, modifications and equivalents may be used. Therefore, the above embodiments should not be construed as limiting.

1. A method (300) for charging battery modules (4) using a charger system (1), the charger system (1) comprising a master DC-source (2) configured to provide a master voltage with a variable magnitude to a plurality of DC/DC-converters (3), wherein each DC/DC-converter in the plurality of DC/DC-converters (3) is configured to provide an output voltage and an output current to charge a respective battery module (4), the method comprising:
obtaining (310) a desired charging voltage for each battery module (4) connected to a respective DC/DC-converter in the plurality of DC/DC-converters (3);
obtaining (320) a possible output current for each DC/DC-converter in the plurality of DC/DC-converters (3) connected to a respective battery module (4);
determining (330) a magnitude of the master voltage in dependency of an estimated power consumption of at least two DC/DC-converters in the plurality of DC/DC-converters (3) connected to a respective battery module (4) if the at least two DC/DC-converter in the plurality of DC/DC-converters (3) connected to a respective battery module (4) would charge the respective connected battery modules (4) with the respective desired charging voltages and the respective possible output currents; and
charging (340) the respective battery modules (4) connected to the at least two DC/DC-converter in the plurality of DC/DC-converters (3) with the respective desired charging voltages, with the respective possible output currents, and with the master DC-source (2) providing the master voltage with the determined magnitude.

2. The method (300) according to claim 1, wherein the magnitude of the master voltage is determined (331) such that the estimated power consumption is equal to or reduced relative to if the master DC-source (2) would provide the master voltage with a nominal magnitude.

3. The method (300) according to claim 1, wherein the magnitude of the master voltage is determined (332) such that the estimated power consumption is minimized.

4. The method (300) according to claim 1, wherein the obtaining (320) of a possible output current for each DC/DC-converter in the plurality of DC/DC-converters (3) connected to a respective battery module (4) comprises:
obtaining (321) a desired charging current for each battery module (4) connected to a respective DC/DC-converter in the plurality of DC/DC-converters (3);
obtaining (322) a total available current from the master DC-source (2); and
determining (323) the possible output current for each DC/DC-converter in the plurality of DC/DC-converters (3) connected to a respective battery module (4) in dependency of the total available current from the master DC-source (2) and of the desired charging currents.

5. The method (300) according to claim 4, wherein the possible output currents are determined (324) based on one or more prioritized battery modules (4) among the connected battery modules (4).

6. The method (300) according to claim 4, wherein the possible charging currents are determined (325) based on a respective state-of-charge, SOC, of one or more of the connected battery modules (4).

7. The method (300) according to claim 4, wherein the desired charging currents are obtained from a respective battery management system, BMS, comprised in each connected battery module (4).

8. The method (300) according to claim 1, wherein the desired charging voltages are obtained from a respective battery management system, BMS, comprised in each connected battery module (4).

9. The method (300) according to claim 1, wherein the estimated power consumption is based on respective voltage conversation ratios of the at least two DC/DC-converters in the plurality of DC/DC-converters (3).

10. The method (300) according to claim 1, wherein the estimated power consumption is based on the respective possible charging currents of the at least two DC/DC-converters in the plurality of DC/DC-converters (3).

11. The method (300) according to claim 1, wherein the desired charging voltage is a voltage over a time period and the possible charging current is a current over a time period.

12. The method (300) according to claim 1, wherein the master DC-source (2) is an AC/DC-converter arranged to convert an AC voltage to the master voltage.

13. A charger system (1) for charging battery modules (4), the charger system (1) comprising:
a master DC-source (2) and a plurality of the DC/DC-converters (3), wherein the master DC-source (2) is configured to provide a master voltage with a variable magnitude to the plurality of DC/DC-converters (3), and wherein each DC/DC-converter in the plurality of DC/DC-converters (3) is configured to provide an output voltage and an output current to charge a respective battery module (4),
a processing circuitry (15) and a memory (16), wherein the processing circuitry (15) is configured to:
obtain a desired charging voltage for each battery module (4) connected to a respective DC/DC-converter in the plurality of DC/DC-converters (3);
obtain a possible output current for each DC/DC-converter in the plurality of DC/DC-converters (3) connected to a respective battery module (4);
determine a magnitude of the master voltage in dependency of an estimated power consumption of at least two DC/DC-converters in the plurality of DC/DC-converters (3) connected to a respective battery module (4) if the at least two DC/DC-converter in the plurality of DC/DC-converters (3) connected to a respective battery module (4) would charge the respective connected battery modules (4) with the respective desired charging voltages and the respective possible output currents; and
charge the respective battery modules (4) connected to the at least two DC/DC-converter in the plurality of DC/DC-converters (3) with the respective desired charging voltages, with the respective possible output currents, and with the master DC-source (2) providing the master voltage with the determined magnitude.

14. The charger system (1) according to claim 13, wherein the magnitude of the master voltage is determined such that the estimated power consumption is equal to or reduced relative to if the master DC-source (2) would provide the master voltage with a nominal magnitude.

15. The charger system (1) according to claim 13, wherein the magnitude of the master voltage is determined such that the estimated power consumption is minimized.

16. The charger system (1) according to claim 13, wherein the processing circuitry (15) is configured to:
obtain desired charging current for each battery module (4) connected to a respective DC/DC-converter in the plurality of DC/DC-converters (3);
obtain a total available current from the master DC-source (2); and
determine the possible output current for each DC/DC-converter in the plurality of DC/DC-converters (3) connected to a respective battery module (4) in dependency of the total available current from the master DC-source (2) and of the desired charging currents.

17. The charger system (1) according to claim 16, wherein the possible output currents are determined based on one or more prioritized battery modules (4) among the connected battery modules (4).

18. The charger system (1) according to claim 16, wherein the possible charging currents are determined based on a respective state-of-charge, SOC, of one or more of the connected battery modules (4).

19. The charger system (1) according to claim 16, wherein the desired charging currents are obtained from a respective battery management system, BMS, comprised in each connected battery module (4).

20. The charger system (1) according to claim 13, wherein the desired charging voltages are obtained from a respective battery management system, BMS, comprised in each connected battery module (4).

21. The charger system (1) according to claim 13, wherein the estimated power consumption is based on respective voltage conversation ratios of the at least two DC/DC-converters in the plurality of DC/DC-converters (3).

22. The charger system (1) according to claim 13, wherein the estimated power consumption is based on the respective possible charging currents of the at least two DC/DC-converters in the plurality of DC/DC-converters (3).

23. The charger system (1) according to claim 13, wherein the desired charging voltage is a voltage over a time period and the possible charging current is a current over a time period.

24. The charger system (1) according to claim 13, wherein the master DC-source (2) is an AC/DC-converter arranged to convert an AC voltage to the master voltage.

25. A computer program product comprising instructions which, when executed on at least one processing circuitry (15), cause the at least one processing circuitry to carry out the method according to claim 1.

26. A computer program carrier carrying a computer program product according to claim 25, wherein the computer program carrier is one of an electronic signal, optical signal, radio signal, or computer-readable storage medium.
